(19) United States
(12) Patent Application Publication
(10) Pub. No.: US 2012/0311009 A1
(43) Pub. Date: Dec. 6, 2012

(54) HYBRID ADDER USING DYNAMIC AND STATIC CIRCUITS

(76) Inventors: Ben D. Jarrett, Austin, TX (US); Justin J. Friesenhahn, Austin, TX (US); Jon A. Loschke, Austin, TX (US)

(21) Appl. No.: 13/462,324

(22) Filed: May 2, 2012

Related U.S. Application Data
(60) Provisional application No. 61/492,063, filed on Jun. 1, 2011.

(51) Int. Cl. G06F 7/50

(52) U.S. Cl. 708/700

(57) ABSTRACT

A hybrid adder may include static partial sum circuits that operate to generate partial sums of operands, where each operand may be divided into groups that include multiple bits. A first subset of the static partial sum circuits may generate a partial sum of a corresponding group of the two or more operands assuming a carry in of 0 to the corresponding group, and a second subset may similarly assume a carry in of 1 to the corresponding group. The adder may further include a dynamic carry tree circuit that generates arithmetic carry signals, where each of the arithmetic carry signals corresponds to a respective group of sum bits. The adder may further include a multiplexer that, during operation, selects each of the groups of sum bits from either of the first or the second subsets of static partial sum circuits dependent upon corresponding ones of the arithmetic carry signals.

### PRIORITY CLAIM

This application claims benefit of priority of U.S. Provisional Patent Appl. No. 61/492,063, filed Jun. 1, 2011, which is incorporated by reference herein in its entirety.

### BACKGROUND

1. Technical Field

This invention is related to the field of processor implementation, and more particularly to techniques for implementing adder circuits.

2. Description of the Related Art

Processors, and other types of integrated circuits, typically include a number of logic circuits composed of interconnected transistors fabricated on a semiconductor substrate. Such logic circuits may be constructed according to a number of different circuit design styles. For example, combinatorial logic may be implemented via a collection of unclocked static complementary metal-oxide semiconductor (CMOS) gates situated between clocked state devices such as flip-flops or latches. Alternatively, depending on design requirements, some combinatorial functions may be implemented via clocked dynamic gates, such as domino logic gates.

One particular type of logic circuit commonly found in many types of integrated circuits is an adder circuit. Typically, an adder circuit includes a collection of devices, such as transistors, interconnected to receive two or more operands and produce the arithmetic sum of the operands as an output. Adders may find application, for example, within integer and/or floating-point units of processors.

Because adder performance can affect overall design performance, it is often necessary to design adders with speed in mind. However, circuit design styles that improve speed often compromise in other respects, such as power consumption and/or design area.

### SUMMARY

Various embodiments of hybrid adders that employ a combination of static and dynamic logic circuits are described. In an embodiment, an adder may include static partial sum circuits that operate to generate partial sums of two or more operands, where each of the two or more operands is divided into groups, and where at least some of the groups include multiple bits. During operation, each of a first subset of the static partial sum circuits may generate a respective partial sum of a corresponding group of the two or more operands assuming a carry in of 0 to the corresponding group, and each of a second subset of the static partial sum circuits may generate a respective partial sum of a corresponding group of the two or more operands assuming a carry in of 1 to the corresponding group. The adder may further include a dynamic carry tree circuit that, during operation, generates a plurality of arithmetic carry signals, where each of the arithmetic carry signals corresponds to a respective group of sum bits, and where at least some groups of sum bits include multiple sum bits. The adder may further include a multiplexer that, during operation, selects each of the groups of sum bits from either of the first or the second subsets of static partial sum circuits dependent upon corresponding ones of the arithmetic carry signals.

In another embodiment, an adder may include multiple static partial sum circuits that, during operation, generate partial sums of the two or more operands, as well as a dynamic carry tree circuit that, during operation, generates a plurality of arithmetic carry signals, and a final sum generation circuit that, during operation, combines the partial sums and the arithmetic carry signals to generate the sum of the two or more operands. The dynamic carry tree circuit may include pulse domino logic gates, where the pulse domino logic gates each include an evaluation network coupled to evaluate one or more inputs during assertion of an evaluate pulse and to selectively discharge a dynamic node dependent upon the one or more inputs, wherein the evaluate pulse is derived from a clock signal and is asserted for a shorter duration than the clock signal is asserted. The pulse domino gates may further include one or more output devices coupled to the dynamic node, wherein during operation, the one or more output devices drive an output node dependent upon the dynamic node.

### BRIEF DESCRIPTION OF THE DRAWINGS

The following detailed description makes reference to the accompanying drawings, which are now briefly described.

FIG. 1 illustrates an embodiment of an adder circuit that may include different circuit design styles.

FIG. 2 illustrates an example of how complexity may be shifted from an adder carry tree to adder partial sum logic.

FIG. 3 illustrates an embodiment of a dynamic carry tree as it might be configured for use in a static logic environment.

FIG. 4 illustrates an embodiment of a circuit that may be incorporated into or coupled to a dynamic logic gate in order to produce a static output.

FIG. 5 illustrates an example of a method of operation of a hybrid adder.

FIG. 6 illustrates an embodiment of a scannable pulse dynamic gate.

FIG. 7 illustrates another embodiment of a scannable pulse dynamic gate.

FIG. 8 illustrates an example of carry tree organization using 3-bit groups.

FIG. 9 illustrates examples of evaluation networks corresponding to code fragments.

FIG. 10 illustrates an embodiment of a processor.

FIG. 11 illustrates an embodiment of a floating-point unit.

FIG. 12 illustrates an embodiment of a system that may include a processor.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component. More generally, the recitation of any element is expressly intended not to invoke 35 U.S.C. §112, paragraph six interpretation for that element unless the language “means for” or “step for” is specifically recited.

### DETAILED DESCRIPTION OF EMBODIMENTS

### Introduction

Adders are ubiquitous in virtually all types of integrated circuits that operate on digital data. For example, adders may be used within processor datapaths to implement programmer-visible instructions of an instruction set architecture (ISA) that explicitly call for the addition (or subtraction) of integers, floating point numbers, partitioned/SIMD arithmetic, and similar operations. Adders may also be employed in contexts less directly visible to programmers, such as in the formation of addresses for loading data or fetching instructions, or in the management of microarchitectural processor data structures whose state cannot be directly observed by executing code.

Adders are often found in the critical execution paths of processors, which dictate the maximum speed at which the processor can operate. (For example, a common critical path in a processor is the data cache load hit path. Data cache access typically depends on formation of an effective address from a base address and an offset, which requires addition.) As operand sizes supported by modern processors increase, it becomes increasingly difficult to ensure that adders will satisfy timing requirements while remaining power- and area-efficient.

In the following discussion, examples of the general logical organization of adders are first examined. Hybrid adder embodiments that employ combinations of static and dynamic logic circuits are then described, including examples of code that models a particular embodiment of a hybrid adder. Specific examples of dynamic logic circuits that might be employed in hybrid adder embodiments are then explored. Finally, an embodiment of a processor that might include variants of the described adders, as well as a system embodiment that might include the processor, are disclosed.

### Adder Organization

Generally speaking, for any given bit position of a sum, a given sum bit depends upon the values of the operands at the same given bit position as the given sum bit, as well as whether there exists a carry in to that given bit position (which in turn depends upon the values of operand bits less significant than the given bit position). Often, the process of generating an arithmetic sum from a set of input operands is functionally segregated along these conceptual lines: some devices are arranged to evaluate the operand bits for each bit position, while other devices are arranged to determine the status of arithmetic carries into each bit position.

Because a carry in to a given bit position of a sum logically depends upon all less significant bits of the operands, the complexity of determining carry status increases as the sizes of the operands increase. Although a variety of adder architectures (e.g., carry lookahead adders, Ling adders, etc.) may be employed to speed the performance of the carry chain, the carry path into or out of the most significant bit of the sum typically determines the performance of a given adder design. By contrast, circuit elements that produce the “partial sum” for a given bit position (i.e., the sum determined from the operand bits without taking the full carry chain into that bit position into account) are typically not critical.

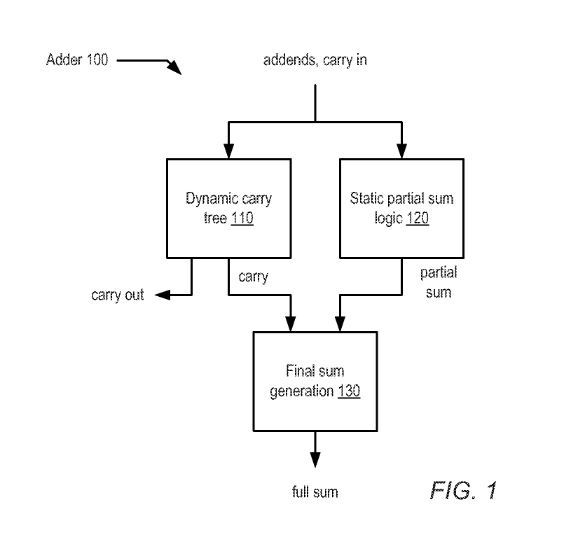

FIG. 1 illustrates an embodiment of an adder circuit that may be organized to implement carry functionality and partial-sum functionality using different circuit design styles. In the illustrated embodiment, adder 100 includes a carry tree 110 as well as a partial sum circuit 120, each of which is coupled to receive input operands such as addends and a carry-in signal (if implemented). Carry tree 110 and partial sum circuit 120 are coupled to final sum circuit 130, which in turn produces the full sum of the input operands.

Partial sum circuit 120 may include circuitry configured to compute the partial sum of one or more bits of the input operands. For example, in an embodiment, a partial sum circuit for a single pair of operand bits may include transistors configured to implement a logical exclusive-OR (XOR) function of the two bits. As discussed in greater detail below, in other embodiments, partial sum circuit 120 may operate on larger groups of bits of the input operands, such as two or more bits.

Carry tree 110 may include circuitry configured to compute the arithmetic carry values into individual bit positions (or into groups of bit positions, depending on the embodiment). For example, carry tree 110 may include transistors that examine bits of the input operands to determine, for each bit position, whether a carry is generated from or propagated across that bit position. (Generally speaking, a carry propagate at a given bit position signifies that although the given bit position does not generate a carry, if there is a carry in to the given bit position from a less significant bit position, there will be a carry out from the given bit position, thus “propagating” the incoming carry across the given bit position.)

Final sum generation circuit 130 may include circuitry configured to combine the partial sum information produced by partial sum circuit 120 with carry information produced by carry tree 110 to produce a final sum. For example, in an embodiment where carry tree 110 produces a carry signal for each bit position, a final sum generation circuit for a given bit position may include transistors arranged to perform an XOR operation on the partial sum bit and the appropriate carry signal for the given bit position.

### Hybrid Static-Dynamic Adders

Semiconductor circuits, like those included in adder 100, may be implemented according to a variety of circuit design styles, including dynamic and static logic. Generally speaking, a clocked dynamic logic circuit (also referred to as a dynamic gate) evaluates its inputs to produce a valid output in response to a control signal, which may correspond to a periodic clock signal or, as described below, a pulse derived from a clock signal. For example, some embodiments of dynamic logic evaluate only when a clock signal is asserted (e.g., driven to a high voltage). During the deasserted phase of the clock signal, such dynamic gates may precharge in preparation for the next evaluate phase. By contrast, the evaluation of a static combinatorial logic circuit (also referred to as a static gate) generally is not controlled by a clock signal. Instead, a static gate may produce its output asynchronously, such that the output changes in response to appropriate changes in the static gate's input.

Generally speaking, dynamic logic circuits may operate at a higher speed than logically equivalent static logic circuits. Thus, dynamic logic circuits may facilitate the design of timing-critical paths within a circuit. However, static logic circuits tend to consume less power and, in some instances, are physically smaller than corresponding dynamic circuits. Further, static logic designs tend to be simpler to design. For example, many automated design tools, such as synthesis tools, exist to simplify the generation of static logic that implements an abstract functional description of a circuit. By contrast, dynamic circuits frequently require more sophisticated tools and/or manual design effort.

In the embodiment shown in FIG. 1, the more performance-critical carry tree 110 may implemented using clocked dynamic logic, such as domino logic, whereas the less performance-critical partial sum circuit 120 may be implemented using static combinatorial logic. In such an embodiment, the overall performance of adder 100 may be faster than if it were entirely implemented using static logic, while the resultant circuit may exhibit smaller size and/or lower power consumption than if it were entirely implemented using dynamic logic.

Given that the carry tree typically determines an adder's critical path, it may be desirable to shift functionality from the critical carry tree to the less-critical partial sum logic, if possible. Reallocating the functional burden in this manner may help to reduce the size and/or increase the performance of the carry tree. Although moving functionality into the partial sum logic may increase its size and/or reduce its performance, in some circumstances, the net effect for the adder as a whole may be beneficial.

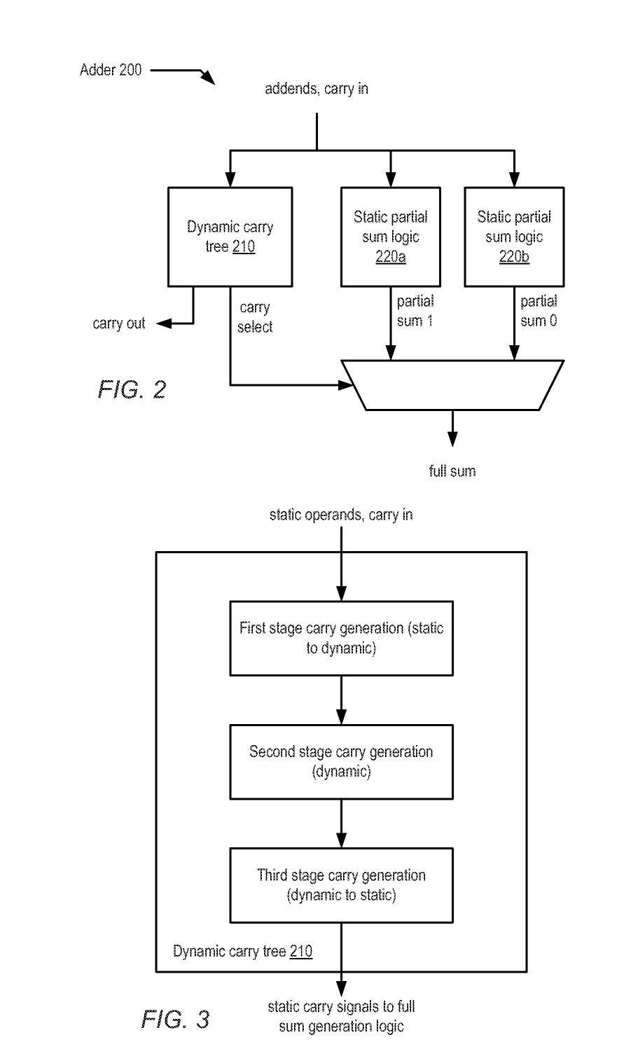

FIG. 2 illustrates an example of how complexity may be shifted from the carry tree to the partial sum logic. In the illustrated embodiment, adder 200 includes dynamic carry tree 210 as well as two instances of static partial sum logic 220a-b. In contrast to adder 100, rather than a final adder stage, adder 200 includes a multiplexer that produces the final sum.

The general configuration of adder 200 may also be referred to as a carry-select adder. Operationally, each instance of partial sum logic 220a-b may be constructed to compute the partial sum of a multiple-bit portion of the input operands, under different assumptions regarding the input carry. Specifically, partial sum logic 220a may compute a partial sum under the assumption that a carry in to its corresponding group of input bits is 1, whereas partial sum logic 220a may compute a partial sum of the same input bits assuming a carry in of 0. Carry tree 210 may in parallel determine the actual carry in to each group of bits, which may then be used to control a multiplexer that selects either the result of partial sum logic 220a or the result of partial sum logic 220b. Because carry tree 210 only needs to generate carry signals for groups of bits rather than individual bits, it may require fewer levels of logic and/or less complex logic, and may therefore be realized using smaller and/or faster circuits.

For example, suppose adder 200 is a 32-bit adder and that each instance of partial sum logic 220a-b is configured to generate a two-bit partial sum. In such an embodiment, 16 instances of partial sum logic 200a and 16 instances of partial sum logic 200b may be implemented. For example, one pair of partial sum logic instances 200a-b may compute a partial sum of bits 1:0 of two or more operands, another pair of instances may operate on bits 3:2 of the operands, and so forth. Similarly, carry tree 210 may generate 16 carry signals. For example, the carry in to bits 1 and 0 may be determined externally, and 15 carry signals generated by carry tree 210 may control 15 multiplexers corresponding to groups 31:30, 29:28 . . . 3:2, and the final carry signal generated by carry tree 210 may correspond to the carry out of bit 31 of adder 200.

It is noted that in various embodiments, any suitable group size may be employed. For example, as described in greater detail below, a 76-bit carry tree might be implemented using 26 groups of 3 bits each. FIG. 8 illustrates an example of how such a carry tree might be organized over four levels of logic. In the first logic level, adjacent groups of 3 bits may be combined. In the second logic level, adjacent groups from the first logic level may be combined, and in the third logic level, adjacent groups from the second logic level may be combined. Finally, in the fourth logic level, final carry-in signals for each group may be determined. As illustrated in FIG. 8, not every one of the 26 groups may require four full levels of logic to compute the final carry-in signals; fewer levels may be used as necessary.

FIG. 3 illustrates an embodiment of dynamic carry tree 210 as it might be configured for use in a static logic environment (e.g., an environment employing static inputs and/or outputs). In the illustrated embodiment, carry tree 210 is shown as being implemented in three distinct stages, although other embodiments may employ more or fewer stages of logic. In the first stage of logic, at least some static inputs may be received and processed to produce a dynamic output. For example, some or all of the operand signals may be encoded in a static format, meaning (as discussed above) that the validity of the signals need not be specifically correlated to a specific state or phase of a clock signal, unlike a dynamic signal which is clock-dependent. The second stage of logic may be purely dynamic, while the third stage of logic may be dynamic logic that produces at least some static outputs.

Regarding static-to-dynamic conversion as may be used in the first stage, generally speaking, care may be needed when interfacing static signals to dynamic logic. For example, many types of dynamic logic (such as domino logic) are implemented using a dynamic node that is precharged during one phase of operation and conditionally discharged during an evaluate phase of operation. If an input to such a gate unintentionally transitions during the evaluate phase (e.g., due to noise or a transient “glitch” in the circuit driving the input), such a transient signal might cause the dynamic node to discharge even though under steady-state conditions it would not have discharged. Such input transitions may result in incorrect circuit behavior.

Apart from state elements such as latches and flip-flops, static logic circuits are asynchronous, meaning that if the inputs to the static circuit arrive at different times, the output of the static circuit might transition one or more times before reaching a steady state. Viewed another way, a static gate's output generally is not stable until all of the gate's inputs are stable, and an unintended transition on an input may yield a corresponding transition on the static output. Thus, without proper conditioning, directly interfacing static signals to dynamic circuits may risk operational failure.

The first stage of logic illustrated in FIG. 3 may include circuitry that conditions the static inputs so that they may be applied to dynamic circuitry without the risk of unintended behavior described above. For example, in some embodiments, static inputs may pass through a static state element, such as a latch or flip-flop, prior to driving any dynamic circuitry. Typically, state elements exhibit synchronous behavior, in that the output of a state element depends on the state of a clock signal. For example, unlike asynchronous static gates, whose outputs may change at any time in response to input changes, a transition on the output of a static state element may require that a clock signal exhibit a particular state, such as a level (e.g., high or low) or edge (e.g., rising or falling). Thus, if the clock signal does not exhibit the requisite state, the state element output may remain stable, providing a degree of timing certainty for the downstream dynamic logic that receives the state element output.

In some instances, static state elements may present an unacceptable degree of delay. Thus, in some embodiments, other techniques may be employed to condition static inputs prior to their use by dynamic logic. For example, a logic NOR gate may be used to combine the static signal with an appropriate clock signal. When the clock signal is asserted, the NOR gate output will be forced to a deasserted (e.g., low) state regardless of the state of the static signal, thus isolating a downstream dynamic gate from transitions on the static signal. When the clock signal is deasserted, the NOR gate output will pass the inverse of the static signal. Thus, in some ways, use of a NOR gate to qualify a static input may mimic the synchronizing behavior of a transparent latch without implementing the latch's storage capability (and thus without the associated cost of this capability).

In some embodiments, pulse dynamic gates may be used to condition static inputs. Pulse dynamic gates are discussed in greater detail below. Generally speaking, however, the evaluation of pulse dynamic gates may be controlled by a pulse that is derived from a clock signal. The length of the pulse and its occurrence relative to an edge of the clock signal may be tailored for the specific timing needs of a particular dynamic gate. Thus, for example, instead of being sensitive to any input transitions during an entire evaluate phase of a clock signal, a pulse dynamic gate may only respond to input transitions that occur during the narrower period of time that the pulse is asserted. The use of pulses in this fashion may further insulate dynamic gates from glitching that may occur on static inputs. For example, if evaluation of a dynamic gate is controlled by a pulse that is asserted only during the latter half of a clock signal's evaluate phase, transitions of a static input during the first half of the evaluate phase will not affect the behavior of the pulsed gate. By contrast, such inputs would potentially affect a dynamic gate whose evaluation is controlled by the clock signal itself.

It is noted that any of the foregoing techniques for handling static-to-dynamic interfacing, or any other suitable techniques, may be employed within carry tree 210. Moreover, it is contemplated that different combinations of techniques may be employed in the same embodiment, and that in some embodiments, not every input to carry tree 210 need necessarily be a static input.

The second stage of logic illustrated in FIG. 3 may, in various embodiments, be implemented in either clocked dynamic logic whose evaluation occurs in response to a particular phase of a clock signal, or pulse dynamic logic as described above with respect to the first stage of logic. In some embodiments, dynamic gates such as those included in any stage of FIG. 3 may be coupled to receive inputs and/or generate outputs that are encoded in a 1-of-N format. Generally speaking, in a 1-of-N format, a signal may have N individual components, at most one of which may be asserted or logically true at a given time. Individual components of a 1-of-N signal may be implemented by a corresponding wire or metal trace that is coupled to one or more corresponding devices within the evaluation network of a particular dynamic gate, as described in greater detail below. For example, a 1-of-4 input signal may be implemented as a bundle of four wires routed to a pulse dynamic gate or a clocked dynamic gate, of which at most 1 wire may be driven to a high voltage (corresponding to assertion) at a given time. In some instances, 1-of-N encoding may result in fewer wires and/or devices changing state during evaluation, which may in turn reduce power consumption relative to other dynamic logic encoding schemes such as dual-rail dynamic logic (in which each bit of a data value is encoded on two wires that represent true and complement states of that bit).

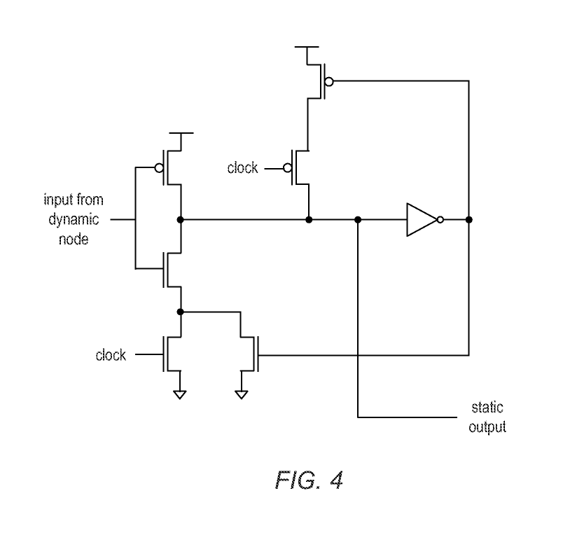

The third stage of logic illustrated in FIG. 3 may be implemented in dynamic logic that, in various embodiments, is either configured to produce a static output or is followed by additional circuitry to convert a dynamic signal to a static signal. FIG. 4 illustrates an embodiment of a circuit that may be incorporated into or coupled to a dynamic logic gate in order to produce a static output. In the illustrated embodiment, the primary inputs to the circuit are a clock signal and the dynamic node (also referred to as the precharge node) of a dynamic gate. Generally speaking, the dynamic node may be precharged to an asserted (e.g., high) state when the dynamic gate is in a precharge state of operation (e.g., when the clock signal is deasserted). When the dynamic gate is in an evaluate mode of operation (e.g., when the clock signal is asserted), the dynamic node may either discharge to a deasserted state or remain in the precharged state, depending on the state of the inputs to the gate and the logical function implemented by the gate. Typically, the state of the dynamic node is inverted to generate a dynamic output, such that a low state on the dynamic node indicates a high output and vice versa.

The circuit of FIG. 4 may operate as follows. First, assume that during the evaluate phase, the clock input is in a high state and the dynamic node input has discharged to a low state, indicating that a high output should be generated. Because the clock input is asserted, the inverter coupled to the dynamic node generates a high output, which is driven to the static output and also drives a feedback inverter. When the clock input is deasserted to begin the next precharge phase, the inverter coupled to the dynamic node is disabled, but the feedback inverter and deasserted clock enable the two series P-channel transistors and cause the high static output to be preserved even though the dynamic node input has returned to a high precharged state.

Second, assume that during the evaluate phase, the dynamic node input remains in a high precharged state, indicating that a low output should be generated. Because the clock input is asserted, the inverter coupled to the dynamic node generates a low output, which is driven to the static output and also drives the feedback inverter. When the clck input is deasserted to begin the next precharge phase, the feedback inverter enables the N-channel pulldown transistor which keeps the input inverter enabled during the precharge phase. Thus, the feedback path causes the low static output to be preserved.

As discussed above, the circuit of FIG. 4 allows the value of a static output to be preserved throughout a full clock cycle, such that the static output may change state in response to a change in the evaluate-mode state of the dynamic node without responding to precharge-mode transitions of the dynamic node. Thus, the static output of FIG. 4 does not return to a low state during precharge mode, as would a typical dynamic signal. Instead, if the static output is asserted during the evaluate phase, it may remain asserted until the beginning of the following evaluate phase, whereupon its state will reflect the next evaluated state of the dynamic node (i.e., either remaining asserted or changing to a deasserted state, depending on the evaluated state of the dynamic node).

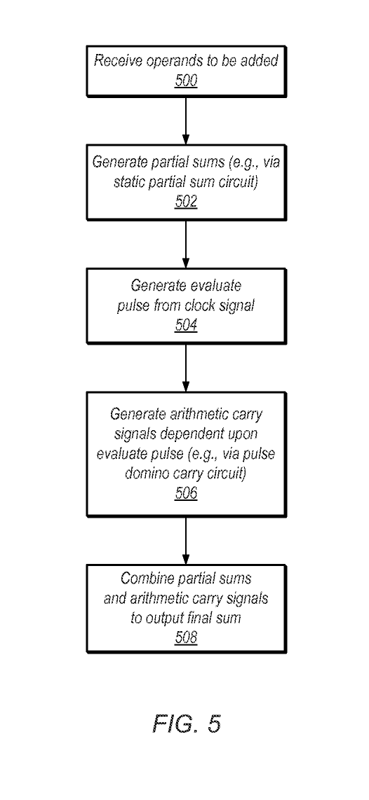

FIG. 5 illustrates an example of a method of operation of a hybrid adder circuit that employs static partial sum generation logic along with a dynamic carry tree circuit. For example, FIG. 5 may be illustrative of the operation of adder 100 or adder 200, as described above and shown in FIGS. 1-2.

In the illustrated embodiment, operation begins in block 500 where operands to be added are received. Partial sums of the operands may then be generated (block 502). For example, static partial sum logic 120 or 220 may operate to generate partial sums as described above.

An evaluate pulse may also be generated from a clock signal (block 504). As mentioned above, and described in greater detail below, an evaluate pulse may be generated such that it is asserted for a narrower period of time than the clock signal from which it is generated, allowing for greater control over the evaluate timing of a dynamic logic circuit.

Arithmetic carry signals may be generated dependent upon the evaluate pulse (block 506). For example, dynamic carry tree circuit 110 or 210 may operate to generate the carry signals as described above. In some embodiments, the arithmetic carry signal for a given bit position or group of bits may reflect one of three possible states: a halt state, indicating that a carry in to the bit position or group will not propagate across that bit position or group under any circumstances; a propagate state, indicating that if a carry in to the bit position or group occurs, that carry will be propagated across the bit position or group; and a generate state, indicating that the bit position or group will generate a carry regardless of whether any carry in from less significant positions occurs. Correspondingly, in some embodiments, an arithmetic carry signal may be encoded in 1-of-N format as a 1-of-3 signal, in which each of the halt, propagate, and generate states is explicitly encoded as an element of the signal.

However, it is noted that in some embodiments where dynamically encoded arithmetic carry signals will eventually be converted back to static logic, explicit encoding of the halt state may be unnecessary. In some such embodiments, the halt state may be omitted from the arithmetic carry signals, such that the arithmetic carry signals explicitly encode a propagate signal and a generate signal without explicitly encoding a halt signal. Omission of a halt signal from the arithmetic carry signal may reduce the overall number of wires needed to route the carry signals as well as devices in the carry logic, which may in turn reduce area and power requirements for the carry tree.

The partial sums and arithmetic carry signals may then be combined to output a sum of the operands (block 508). For example, the final sum may be determined by final sum generation circuit 130 as shown in FIG. 1, or by the multiplexer shown in FIG. 2, among other possible embodiments.

It is noted that although some of the operations just described are shown sequentially in FIG. 5, it is contemplated that these operations may occur concurrently or in a different order than that shown. For example, partial sum generation and carry generation may occur concurrently.

### Example Design-Language Representation of a Hybrid Adder Embodiment

The following code describes an embodiment of carry tree 210 arranged in the manner shown in FIG. 3 to implement a dynamic carry tree for a 78-bit adder organized in partial sum groups of 3 bits. Under the conventions employed in this code, the syntax [n:m,step,skip] is used to condense multiple expressions encompassing a range of values into a single expression. Generally speaking, this expression expands into a list of values from n to m, where step denotes the increment/decrement used to progress from one list member to the next (defaults to 1), and where skip denotes the number of list members to omit between steps. Thus, for example, B[7:0,2] results in the list B7_6, B5_4, B3_2, B1_0, whereas B[7:0,2,1] omits every other list member to yield the list B7_6, B3_2.

Additionally, the suffix _xyz represents information about a signal, where x denotes the radix of the signal (e.g., the number of wires included in the signal), y denotes the type of the signal (e.g., S denotes a static signal, and h denotes a dynamic 1-of-N signal where N is the radix x), and z denotes the clock phase associated with the signal.

The use of dot notation in the following source code is a compact representation for determining whether a signal encodes a particular value. Generally speaking the notation x.y is equivalent to the test “x==y”, where ==denotes the Boolean equivalence test as defined in, e.g., the C programming language. In some embodiments, the various instances of expressions of the form x.y within a given equation may correspond to respective instances of transistors within the evaluation network of a dynamic gate corresponding to that equation. Further, the various operators used in the equation may be understood to express not only a logical relationship between signals but also a physical relationship between devices. For example, the && operator may be interpreted to denote transistors or networks of transistors connected in series within the evaluation network, while the ∥ operator may be interpreted to denote parallel connections. When used between expressions, the * operator may be interpreted to denote a series connection between the devices or networks corresponding to the expressions.

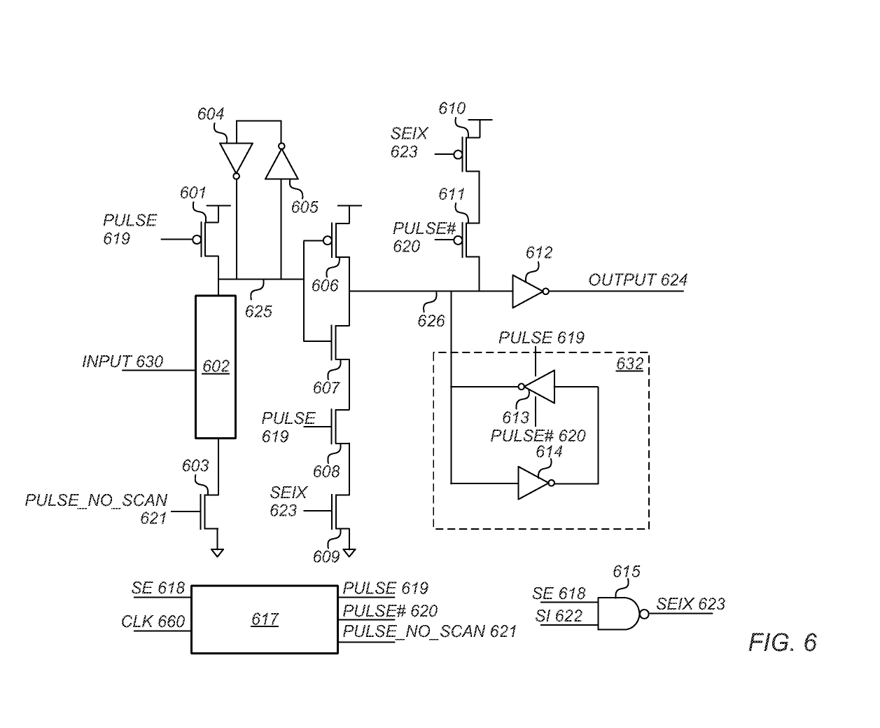

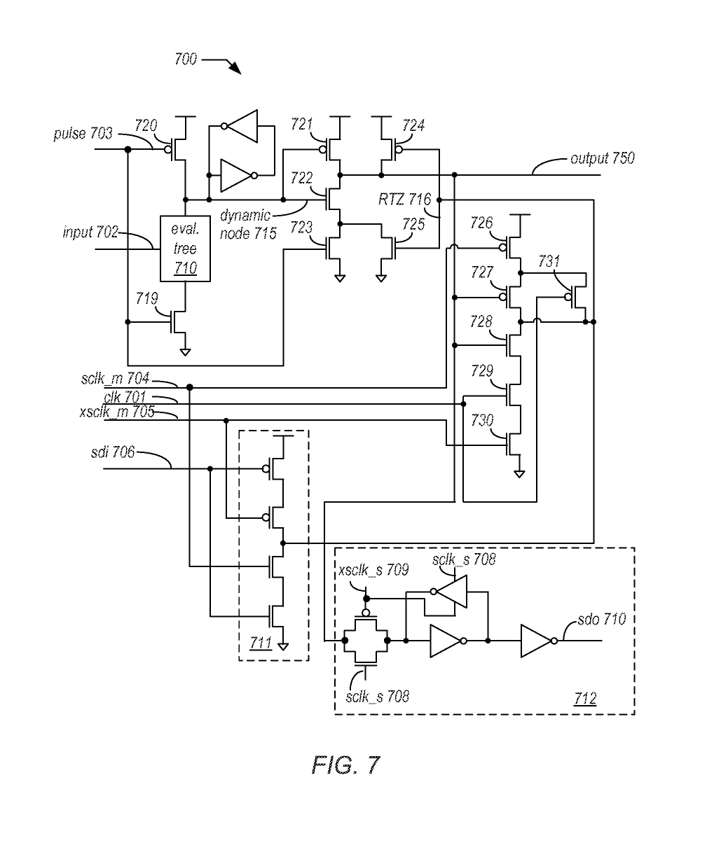

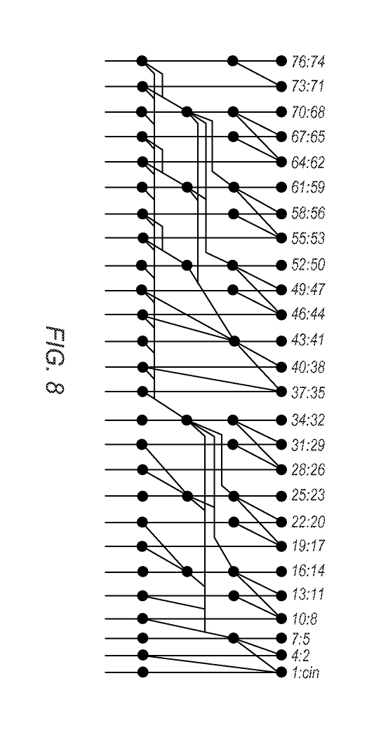

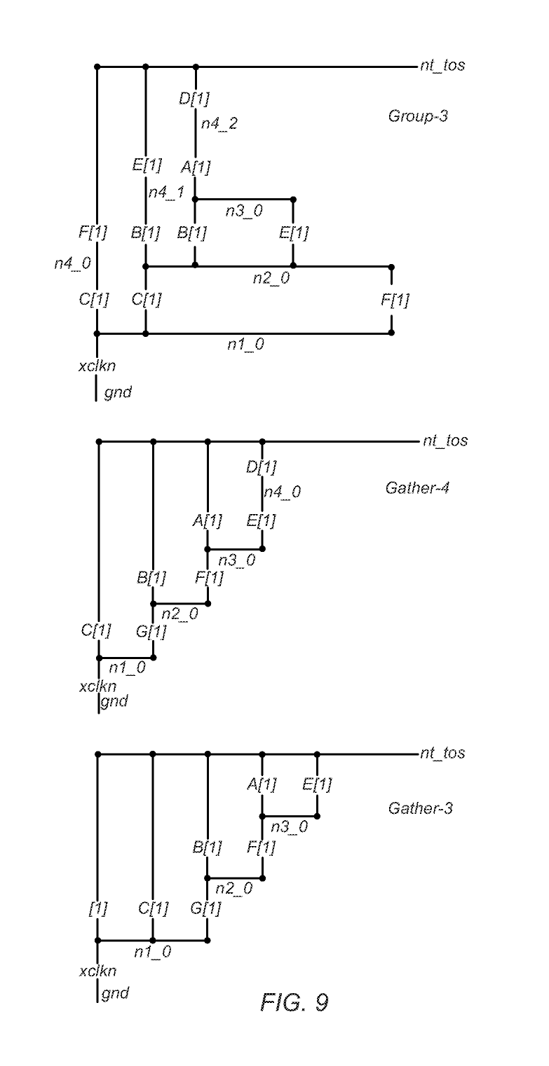

It is noted that the syntax just described may enable a designer to precisely define the arrangement of transistors within an evaluation network, tree, or “stack” of a dynamic logic gate (e.g., within evaluation networks 602 or 710 shown in FIGS. 6-7 and discussed below). To facilitate understanding of how the syntax maps to a physical arrangement of transistors, FIG. 9 illustrates abstract examples of evaluation networks that correspond to the following code fragments, respectively denoted “Group-3,” “Gather-4,” and “Gather-3.”

```
Group-3
g_B[77:5,3]_g0_1h0 =
  (a_B[76:4,1,2]_1S0.V0 && b_B[76:4,1,2]_1S0.V0) * V0 |
  (a_B[76:4,1,2]_1S0.V0 ||
b_B[76:4,1,2]_1S0.V0) * ((a_B[75:3,1,2]_1S0.V0 &&
b_B[75:3,1,2]_1S0.V0) * V0 |
  (a_B_[75:3,1,2]_1S0.V0 ||
b_B[75:3,1,2]_1S0.V0) * ((a_B[74:2,1,2]_1S0.V0 &&
b_B[74:2,1,2]_1S0.V0) * V0));
Gather-4
g_B[71:0,36]_g2_1h0 =
  (g_B[71:27,9,3]_g1_1h0.V0 * V0 |
p_B[71:27,9,3]_g1_1h0.V0 * (g_B[62:18,9,3]_g1_1h0.V0 * V0 |
p_B[62:18,9,3]_g1_1h0.V0 * (g_B[53:9,9,3]_g1_1h0.V0 * V0 |
p_B[53:9,9,3]_g1_1h0.V0 * (g_B[44:0,9,3]_g1_1h0.V0 * V0))));
Gather-3
n_c_B41_1S1 =
  (ndl_init_buf_SS.V0 * V0 |
g_B41_39_g0_1h0.1 * 1 |
p_B41_39_g0_1h0.1 * (g_B38_36_g0_1h0.1 * 1 |
p_B38_36_g0_1h0.1 * (g_B35_0_g2_1h0.1 * 1 |
p_B35_0_g2_1h0.1 * 1)));
```

In FIG. 9, each device within the evaluation network that is coupled to a data input is denoted by a single letter (e.g., A-G) corresponding to that input. The clocked evaluation device that causes the evaluation network to evaluate its inputs is denoted “xclkn.” The dynamic node or “top-of-stack” node, denoted “nt_tos,” is ordinarily precharged to a precharge voltage during the precharge phase of operation and conditionally discharged through the evaluation network during the evaluate phase of operation dependent upon the state of the data inputs. For reference, intermediate nodes within the evaluation network are denoted with unique labels such as “n1_0,” “n2_0,” etc.

Generally speaking, the sequence of terms on the right side of the “=” in this code syntax may be interpreted in order to define an evaluation network from left to right and from bottom to top. Thus, considering the Group-3 code example, the first two terms joined by the “&&” symbol correspond to the series C[1] and F[1] devices shown at the left of the corresponding network, joined by node n4_0. The next two terms, joined by the “H” symbol, correspond to the parallel C[1] and F[1] devices at the bottom right of the network, joined between nodes n1_0 and n2_0. The next two terms, joined by the “&&” symbol, correspond to the series B[1] and E[1] devices joined by node n4_1, while the following two terms, joined by the “∥” symbol, correspond to the parallel B[1] and E[1] devices joined between nodes n2_0 and n3_0. The final two terms, joined by the “&&” symbol, correspond to the series A[1] and D[1] devices joined by node n4_2, completing the specification of the evaluation network for this particular gate. The Gather-4 and Gather-3 examples may be interpreted in a similar fashion to specify their respective evaluation networks as shown in FIG. 9.

The full source code illustrating an example implementation of carry tree 210 follows.

#define PGT 3
#define HLT1 1
#define GEN1 1
#define PGT1 1
module (ndl) fp_ct78_ndl {
#include “clocks.h”

| in | n_a_B[76:0]_1S0; |
|---|---|
| in | n_b_B[76:0]_1S0; |
| in | n_cin_1S0; |
| in | enable_1S0; |
| in | enable1_1S0; |
| in spare_input_c[25:0]_1S0; | |
| out | n_c_B[77:2,1,2]_1S1; |

[a,b]_B[76:0]_1S0 = !n_[a,b]_B[76:0]_1S0;
cin_1S0 = !n_cin_1S0;

enable((PHASEBUF_EN_C0(enable_1S0,add_prim_gclk_C0))) {

//////////////////////////////////////////////////////////////

// g0 PULSE gates
////////////////////////////////////////////////////////////////

```
  //SNET g_B[77:5,3]_g0_1h0;
  g_B[77:5,3]_g0_1h0 =
```

```
  (a_B[76:4,1,2]_1S0.V0 && b_B[76:4,1,2]_1S0.V0) * V0 |
  (a_B[76:4,1,2]_1S0.V0 ||
  b_B[76:4,1,2]_1S0.V0) * ((a_B[75:3,1,2]_1S0.V0 && b_B[75:3,1,2]_1S0.V0) * V0 |
```

(a_B[75:3,1,2]_1S0.V0 ||

b_B[75:3,1,2]_1S0.V0) * ((a_B[74:2,1,2]_1S0.V0 &&

b_B[74:2,1,2]_1S0.V0) * V0));

g_B2_0_g0_1h0 =

```
  (a_B1_1S0.V0 && b_B1_1S0.V0) * V0 |
  (a_B1_1S0.V0 ||
  b_B1_1S0.V0) * ((a_B0_1S0.V0 && b_B0_1S0.V0) * V0 |
```

(a_B0_1S0.V0 ||
b_B0_1S0.V0) * (cin_1S0.1 * 1));

```
    //SNET p_B [77:5,3]_g0_1h0;
    p_B[77:5,3]_g0_1h0 =
```

```
  (a_B[76:4,1,2]_1S0.V0 ||
    b_B[76:4,1,2]_1S0.V0) * ((a_B[75:3,1,2]_1S0.V0 ||
```

b_B[75:3,1,2]_1S0.V0) * ((a_B[74:2,1,2]_1S0.V0 ||

b_B[74:2,1,2]_1S0.V0) * V0));

p_B2_0_g0_1h0 =

```
  (a_B1_1S0.V0 ||
    b_B1_1S0.V0) * ((a_B0_1S0.V0 ||
```

b_B0_1S0.V0) * (cin_1S0.1 * 1));

}

```
  /////////////////////////////////////////////////////////////////////
  // g1 group and pg gates (less critical)
  /////////////////////////////////////////////////////////////////////
```

```
    //enable((PHASEBUF_EN_C0(enable_b_1S0,add_ss_gclk_C0))) {
    enable((PHASEBUF_EN_C0(enable_1S0,add_ss_gclk_C0))) {
```

g_B[77_72,68_63,59_54,50_45]_g1_1h0 =

```
  (g_B[77:48,3,2]_g0_1h0.V0 * V0 |
  p_B[77:48,3,2]_g0_1h0.V0 * (g_B[74:45,3,2]_g0_1h0.V0 * V0));
```

g_B[32_27,23_18,14_9]_g1_1h0 =

```
  (g_B[32:12,3,2]_g0_1h0.V0 * V0 |
  p_B[32:12,3,2]_g0_1h0.V0 * (g_B[29:9,3,2]_g0_1h0.V0 * V0));
```

p_B[77_72,68_63,59_54,50_45]_g1_1h0 =

p_B[77:48,3,2]_g0_1h0.V0 * (p_B[74:45,3,2]_g0_1h0.V0 * V0);

p_B[32_27,23_18,14_9]_g1_1h0 =

p_B[32:12,3,2]_g0_1h0.V0 * (p_B[29:9,3,2]_g0_1h0.V0 * V0);

////////////////////////////////////////////////////////////////

// g1 group and pg gates (more critical)
///////////////////////////////////////////////////////////////

g_B[71:0,9]_g1_1h0 =

```
  (g_B[71:6,3,2]_g0_1h0.V0 * V0 |
  p_B[71:6,3,2]_g0_1h0.V0 * (g_B[68:3,3,2]_g0_1h0.V0 * V0 |
```

p_B[68:3,3,2]_g0_1h0.V0 * (g_B[65:0,3,2]_g0_1h0.V0 *

V0)));

p_B[71:0,9]_g1_1h0 =

p_B[71:6,3,2]_g0_1h0.V0 && p_B[68:3,3,2]_g0_1h0.V0 && p_B[65:0,3,2]_g0_1h0.V0;

////////////////////////////////////////////////////////////////

// g2 group and pg gates (more critical)
////////////////////////////////////////////////////////////////

g_B53_36_g2_1h0 =

```
  (g_B53_45_g1_1h0.V0 * V0 |
  p_B53_45_g1_1h0.V0 * (g_B44_36_g1_1h0.V0 * V0));
```

g_B17_0_g2_1h0 =

```
  (g_B17_9_g1_1h0.V0 * V0 |
  p_B17_9_g1_1h0.V0 * (g_B8_0_g1_1h0.V0 * V0));
```

p_B53_36_g2_1h0 =

p_B53_45_g1_1h0.V0 * (p_B44_36_g1_1h0.V0 * V0);

p_B17_0_g2_1h0 =

p_B17_9_g1_1h0.V0 * (p_B8_0_g1_1h0.V0 * V0);

g_B62_36_g2_1h0 =

```
  (g_B62_54_g1_1h0.V0 * V0 |
  p_B62_54_g1_1h0.V0 * (g_B53_45_g1_1h0.V0 * V0 |
```

p_B53_45_g1_1h0.V0 * (g_B44_36_g1_1h0.V0 * V0)));

g_B26_0_g2_1h0 =

```
  (g_B26_18_g1_1h0.V0 * V0 |
  p_B26_18_g1_1h0.V0 * (g_B17_9_g1_1h0.V0 * V0 |
```

p_B17_9_g1_1h0.V0 * (g_B8_0_g1_1h0.V0 * V0)));

p_B62_36_g2_1h0 =

p_B62_54_g1_1h0.V0 * (p_B53_45_g1_1h0.V0 * (p_B44_36_g1_1h0.V0 * V0));

p_B26_0_g2_1h0 =

p_B26_18_g1_1h0.V0 * (p_B17_9_g1_1h0.V0 * (p_B8_0_g1_1h0.V0 * V0));

g_B[71:0,36]_g2_1h0 =

```
  (g_B[71:27,9,3]_g1_1h0.V0 * V0 |
  p_B[71:27,9,3]_g1_1h0.V0 * (g_B[62:18,9,3]_g1_1h0.V0 * V0 |
```

p_B[62:18,9,3]_g1_1h0.V0 * (g_B[53:9,9,3]_g1_1h0.V0 *

V0 |

p_B[53:9,9,3]_g1_1h0.V0 *

(g_B[44:0,9,3]_g1_1h0.V0 * V0))));

p_B[71:0,36]_g2_1h0 =

p_B[71:27,9,3]_g1_1h0.V0 && p_B[62:18,9,3]_g1_1h0.V0 && p_B[53:9,9,3]_g1_1h0.V0 &&

p_B[44:0,9,3]_g1_1h0.V0;
}

///////////////////////////////////////////////////////////////

```
// carry outs
/////////////////////////////////////////////////////////////
    //enable((PHASEBUF_EN_C1(enable1_b_1S0, add_gclk_C1))) {
    enable((PHASEBUF_EN_C1(enable1_1S0, add_gclk_C1))) {
```

```
n_c_B2_1S1 =
  (ndl_init_buf_SS.V0 * V0 |
  g_B2_0_g0_1h0.1 * 1 |
  p_B2_0_g0_1h0.1 * 1);
n_c_B5_1S1 =
  (ndl_init_buf_SS.V0 * V0 |
```

g_B5_3_g0_1h0.1 * 1 |
p_B5_3_g0_1h0.1 * (g_B2_0_g0_1h0.1 * 1 |

p_B2_0_g0_1h0.1 * 1));

```
n_c_B[29:9,1,8]_1S1 =
  (ndl_init_buf_SS.V0 * V0 |
  g_B[29:9,1,8]_[27:9,1,8]_g0_1h0.1 * 1 |
  p_B[29:9,1,8]_[27:9,1,8]_g0_1h0.1 * (g_B[26:8,1,8]_0_g[2,2,1]_1h0.1 * 1 |
```

p_B[26:8,1,8]_0_g[2,2,1]_1h0.1 * 1));

```
n_c_B[32:9,1,8]_1S1 =
  (ndl_init_buf_SS.V0 * V0 |
  g_B[32:9,1,8]_[27:9,1,8]_g1_1h0.1 * 1 |
  p_B[32:9,1,8]_[27:9,1,8]_g1_1h0.1 * (g_B[26:8,1,8]_0_g[2,2,1]_1h0.1 * 1 |
```

p_B[26:8,1,8]_0_g[2,2,1]_1h0.1 * 1));

```
n_c_B[35:8,1,8]_1S1 =
  (ndl_init_buf_SS.V0 * V0 |
  g_B[35:8,1,8]_0_g[2,2,2,1]_1h0.1 * 1 |
  p_B[35:8,1,8]_0_g[2,2,2,1]_1h0.1 * 1);
n_c_B38_1S1 =
  (ndl_init_buf_SS.V0 * V0 |
  g_B38_36_g0_1h0.1 * 1 |
  p_B38_36_g0_1h0.1 * (g_B35_0_g2_1h0.1 * 1 |
```

p_B35_0_g2_1h0.1 * 1));

n_c_B41_1S1 =
(ndl_init_buf_SS.V0 * V0 |

g_B41_39_g0_1h0.1 * 1 |
p_B41_39_g0_1h0.1 * (g_B38_36_g0_1h0.1 * 1 |

p_B38_36_g0_1h0.1 * (g_B35_0_g2_1h0.1 * 1 |

p_B35_0_g2_1h0.1 * 1)));;

```
n_c_B[74:42,1,8]_1S1 =
  (ndl_init_buf_SS.V0 * V0 |
  g_B[74:42,1,8]_[72:39,1,8]_g0_1h0.1 * 1 |
  p_B[74:42,1,8]_[72:39,1,8]_g0_1h0.1 * (g_B[71:36,1,8]_36_g[2,2,2,1]_1h0.1 * 1 |
```

p_B[71:36,1,8]_36_g[2,2,2,1]_1h0.1 *

(g_B35_0_g2_1h0.1 * 1 |
p_B35_0_g2_1h0.1 * 1)));

```
n_c_B[77:42,1,8]_1S1 =
  (ndl_init_buf_SS.V0 * V0 |
  g_B[77:42,1,8]_[72:39,1,8]_g1_1h0.1 * 1 |
  p_B[77:42,1,8]_[72:39,1,8]_g1_1h0.1 * (g_B[71:36,1,8]_36_g[2,2,2,1]_1h0.1 * 1 |
```

p_B[71:36,1,8]_36_g[2,2,2,l]_1h0.1 *

(g_B35_0_g2_1h0.1 * 1 |
p_B35_0_g2_1h0.1 * 1)));

```
n_c_B[71:44,1,8]_1S1 =
  (ndl_init_buf_SS.V0 * V0 |
  g_B[71:44,1,8]_36_g[2,2,2,1]_1h0.1 * 1 |
  p_B[71:44,1,8]_36_g[2,2,2,1]_1h0.1 * (g_B35_0_g2_1h0.1 * 1 |
```

p_B35_0_g2_1h0.1 * 1));

}
// spare gates
ipragma nowarn spare_gate_r0_c[25:0][a,b]_1S0 ;
inst na2(“spare_gate_r0_c[25:0][a,b]_1S0”,

| | |
|---|---|
| “o” | spare_gate_r0_c[25:0][a,b]_1S0, |
| “i0” | spare_input_c[25:0]_1S0, |
| “i1” | spare_input_c[25:0]_1S0 |

```
    );
    //inst na2(“spare_gate_r1_c[25:0][a,b]_1S0”,
```

| | | |
|---|---|---|
| // | “o” | spare_gate_r1_c[25:0][a,b]_1S0, |
| // | “i0” | spare_gate_r0_c[25:0][a,b]_1S0, |
| // | “i1” | spare_gate_r0_c[25:0][a,b]_1S0 |

//);
}

The following code describes an embodiment of an adder, such as adder 200, that instantiates the carry tree defined in the code example given above. The adder code includes behavioral statements corresponding to the elements that will be implemented in synthesized static logic, such as the partial sum adders 220a-b. It also includes both behavioral and netlist representations of the multiplexer that chooses between partial sum adders 220a-b based on the carry signals produced by the carry tree. The behavioral representation of the multiplexer, commented out in the code below, clearly expresses the functionality of the multiplexer. The netlist representation reflects the instantiation of specific library cells or elements that implement the functionality reflected by the behavioral representation. For example, the netlist representation could be used to specify a particular logic design, rather than to leave the choice of cells to the discretion of a synthesis tool. (Some optimizing synthesis tools might analyze code such as the below and attempt to remove the multiplexer and the duplicate partial sum adders in an attempt to reduce design area; explicitly specifying the cells to be used may force the tool to synthesize the remaining logic in the manner the designer intended.)

It is noted that in some embodiments, adder 200 may be employed within a design that is largely synthesized by automated design tools. Ordinarily, dynamic logic circuits require custom circuit design and manual analysis, and are not as easily managed within an automated design flow as are static circuits. However, the adder design described above, in conjunction with the coding style described above and related tools for processing mixed static and dynamic logic, may result in an adder that, although including a substantial portion of dynamic logic, nevertheless remains highly compatible with an automated design flow. For example, in some embodiments, adder 200 may work well with industry-standard tools for logic synthesis, automated place-and-route, and static timing analysis, requiring little or no special handling within these flows despite its use of dynamic logic. These aspects of adder 200 may render it more readily usable within a variety of designs than conventional dynamic logic implementations.

### Examples of Dynamic Gate Styles

FIGS. 6-7 illustrate several embodiments of pulse dynamic gates that may be used within dynamic carry tree 210 or elsewhere. It is noted that the illustrated embodiments include devices that allow the gates to be scanned for testability; scan-related functionality is optional and may be omitted in other embodiments. It is also noted that although the illustrated embodiments are controlled with pulses, a standard clock signal (such as the clock signal from which the pulse is derived) may be substituted for the pulse and the pulse generation circuitry may be omitted to yield a clocked dynamic gate. More generally, the illustrated embodiments merely show particular examples of dynamic gates, and various other configurations of such gates are possible and contemplated.

FIG. 6 illustrates an embodiment of a scannable pulse dynamic gate 600. In the illustrated embodiment, input data 630 is coupled to the evaluation network 602, which is in turn coupled to a precharge device 601 and an evaluate device 603. Precharge device 601 is controlled by a pulse signal 619, and evaluate device 603 is controlled by a pulse_no_scan signal 621. A dynamic node 625 is coupled to the evaluation network 602 and precharge device 601 and further coupled to keeper inverters 604 and 605. Dynamic node 625 is further coupled to an inverter formed by devices 606 and 607 and further controlled by pulse 619 (via device 608) and qualified scan signal SEIX 623 (via device 609). The output of the inverter formed by devices 606 and 607 is coupled to latch node 626, which drives output 624 via inverter 612. Latch node 626 is additionally coupled to a storage element 632 (which may also be referred to as a latch stage) and is controlled by SEIX 623 (via pullup device 610) and pulse#620 (via pullup device 611). Latch stage 632 includes a pair of cross-coupled inverters 613 and 614, of which inverter 613 is selectively controlled by pulse 619 and pulse#620.

It is noted that static CMOS inverters, such as those shown and described herein, may be a particular embodiment of an inverting amplifier that may be employed in the circuits described herein. However, in other embodiments, any suitable configuration of inverting amplifier that is capable of inverting the logical sense of a signal may be used, including inverting amplifiers built using technology other than CMOS. Moreover, it is noted that although precharge devices, pullup devices, pulldown devices, and/or evaluate devices may be illustrated as individual transistors, in other embodiments, any of these devices may be implemented using multiple transistors or other suitable circuits. That is, in various embodiments a “device” may correspond to an individual transistor or other switching element of any suitable type (e.g., a FET), to a collection of transistors or switches, to a logic gate or circuit, or the like.

In some embodiments, evaluation network 602 may include a tree of devices such as N-type devices (e.g., NFETs) that are coupled to implement a logic function. For example, in response to a particular combination of inputs, certain corresponding devices within evaluation network 602 may be activated, creating one or more paths to ground. Evaluation network 602 may then discharge dynamic node 625 through such a path or paths. That is, in response to one or more of the inputs satisfying the logical function implemented by evaluation network 602, during assertion of the evaluate pulse, one or more discharge paths through evaluation network 602 may be generated among the devices.

In some embodiments, evaluation network 602 may be coupled to receive inputs encoded in a 1-of-N format. Generally speaking, in a 1-of-N format, an input signal may have N individual components, at most one of which may be asserted or logically true at a given time. Individual components of a 1-of-N signal may be implemented by a corresponding wire or metal trace that is coupled to one or more corresponding devices within evaluation network 602. For example, a 1-of-4 input signal may be implemented as a bundle of four wires routed to scannable pulse dynamic gate 240, of which at most 1 wire may be driven to a high voltage (corresponding to assertion) at a given time. When a particular wire is asserted in this manner, one or more corresponding devices within evaluation network 602 may be activated. Depending on the logical function implemented by evaluation network 602, such activation may or may not affect the output state of scannable pulse dynamic gate 240.

In the illustrated embodiment, clock generator 617 may be configured to generate several variants of a pulse signal from an input clock 660 and a scan enable signal 618. In some embodiments, a pulse may correspond to a signal that is generated from a clock signal but which is asserted for a shorter period of time than the clock signal from which the pulse is generated. That is, a pulse may be understood to be a synchronous signal, like a clock signal, but may have timing characteristics that both differ from and depend on a clock signal. In various embodiments, the occurrence of the rising and/or falling edges of a pulse relative to a clock signal may be tuned based on the timing requirements of a particular gate or path. Both the duration of the pulse and the locations of its edges relative to a clock signal may be varied. For example, the pulse may be generated such that its rising edge occurs after the rising edge of the clock signal and its falling edge occurs before the falling edge of the clock cycle.

As noted above, the usage of pulses to control evaluation of the gate is not essential. In some embodiments clock generator 617 may be modified or omitted, and the input clock 660 (or a different clock, or a combination of appropriate senses/versions of a clock) may be used to directly control the gate.

Using pulses rather than clocks may help to improve circuit performance. In the context of dynamic logic, a synchronous signal usually determines the period of time during which inputs are evaluated. For example, a dynamic logic circuit controlled by a clock signal may evaluate its inputs when the clock signal is high (also referred to as the circuit's “evaluate phase”). When the clock signal is low (also referred to as the circuit's “precharge phase”), the dynamic logic circuit may be insensitive to changes in its inputs. Generally speaking, it is often necessary to ensure that an input signal to a dynamic logic circuit is stable for at least a certain length of time (also referred to as “hold time”) during and/or following the circuit's evaluate phase in order to ensure correct circuit operation. For example, if hold time requirements were not satisfied by the input to a particular gate (that is, if the input began to transition prematurely), the input might fail to be captured by the gate, possibly causing the gate to fail to evaluate correctly. Alternatively, the premature transition may cause the gate to spuriously evaluate (for example, by creating a path within evaluation network 602 that causes dynamic node 625 to discharge when it otherwise would not have). Such behaviors may cause incorrect circuit operation.

To mitigate failures due to hold time violations, designers may adopt circuit design rules that specify minimum hold times for various signals. However, such hold time requirements may limit the speed of circuit operation, because for a gate that generates a given input signal to another gate, longer hold times for the given input signal usually leave less time for the generating gate to do useful work.

In dynamic gates, hold time requirements are often dependent upon the length of the evaluation phase. That is, it is generally unnecessary to hold an input signal beyond the end of the evaluation phase, because a correctly operating dynamic gate should be insensitive to input changes that occur outside of the evaluation phase. By using a pulse instead of a clock signal to control the evaluation of dynamic gates, the length of the evaluation phase of a gate may be shortened (because, as discussed above, pulses have a shorter asserted duration than their corresponding clocks). By shortening the evaluation phase, it may be possible to allow the input signals to transition earlier than if a clock signal were used. That is, use of a pulse may reduce input signal hold time requirements. This in turn may increase the frequency at which the circuit may be able to operate.

As shown in FIG. 3, pulse generator 617 may generate a pulse output 619 as well as a pulse# output 620 that has a logical sense that is the opposite of pulse 619. (That is, when pulse 619 is high, pulse#620 is low and vice versa.) Pulse generator 617 may also generate a pulse_no_scan output 621 that is qualified with scan enable 618 such that when scan enable 618 is asserted (e.g., high or logically true, indicating that a scan mode of operation is active), pulse_no_scan 621 is deasserted (e.g., low or logically false), preventing the discharge of dynamic node 625. Thus, in the illustrated embodiment, pulse generator 617 may generate a free-running pulse 619 that asserts whenever clock 660 is running, as well as a qualified pulse_no_scan 621 that asserts dependent upon whether or not the circuit is operating in scan mode. It is noted that in other embodiments, pulse generator 617 may be configured to generate a different number or configuration of pulses. The timing characteristics of the generated pulses may vary according to the specific implementation constraints of the circuit.

In the illustrated embodiment, NAND gate 615 may be configured to combine scan enable SE 618 with scan data SI 622 to create signal SEIX 623. In functional terms, SEIX 623 may represent inverted scan data qualified with the scan enable signal. That is, if SE 618 is deasserted (e.g., low), SEIX 623 may be high regardless of the value on scan data SI 622. If SE 618 is asserted (e.g., high) to indicate scan mode operation, then SEIX 623 may output the complement of SI 622.

As noted above, in some embodiments scan functionality may be omitted. For example, NAND gate 615 as well as those devices controlled by SEIX 623 may be omitted.

In some embodiments, the illustrated scannable pulse dynamic gate may operate as follows. Operation may depend on whether or not the gate is operating in scan mode. Considering first a normal, non-scan mode of operation, operation may further depend on the state of clock 660. When clock 660 is inactive (low), pulse 619 may also be low, causing dynamic node 625 to be precharged high via device 601. During normal mode operation, scan enable SE 618 is low, causing SEIX 623 to be high as discussed above. This in turn activates device 609.

When clock 660 is active (high) and scan enable SE 618 remains low, pulse generator 617 generates pulse 619, pulse#620, and pulse_no_scan 621. For the duration of these pulses, device 601 is inactive and devices 603, 608, and 611. The state of inputs 360 to evaluation network 602 may be evaluated, during which dynamic node 625 may or may not discharge through evaluation network 602 and device 603. If dynamic node 625 does not discharge in this fashion, a keeper network (shown as keeper inverters 604 and 605) may maintain the precharged state of dynamic node 625 for the duration of the pulses.

The value on dynamic node 625 may then be presented to the latch node. If dynamic node 625 discharges, then the low voltage on dynamic node 625 causes a high voltage to be transferred to latch node 626 via device 606. If dynamic node 625 does not discharge, then when pulse 619 is active, the high voltage on dynamic node 625 causes a low voltage to be transferred to latch node 626 via devices 607, 608, and 609. (As noted above, SEIX 623 is high during normal mode operation, causing device 609 to be activated.) The value of latch node 626 is then inverted and presented as output 624, though in other embodiments, a non-inverted output may additionally or alternatively be provided.

When pulse 619 and pulse#620 are in their active states (e.g., high and low, respectively), tri-state inverter 613 may be placed in a high-impedance state that prevents contention on latch node 626. When pulse 619 and pulse#620 return to inactive states (e.g., low and high, respectively), tri-state inverter 613 may activate and drive latch node 626, causing the value of latch node 626 to be captured and stored via the feedback loop of tri-state inverter 613 and inverter 614.

During a scan mode of operation, as mentioned above, pulse_no_scan 621 will remain inactive, causing dynamic node 625 to remain precharged regardless of the inputs 60 presented to evaluation network 602. During scan mode, the value of latch node 626 may depend on the state of SEIX 623. If scan input data SI 622 is low, SEIX 623 will be high. Combined with the high state of dynamic node 625, this configuration may cause a low voltage to be transferred to latch node 626 when pulse 619 is active. (For this combination of inputs, the high state of SEIX 623 causes device 610 to be inactive.) If scan input data SI 622 is high during scan mode, SEIX 623 will be low, causing device 609 to turn off and device 610 to turn on. When pulse#620 is active (low), device 611 will also be active. This configuration may cause a high voltage to be transferred to latch node 626. The operation of tri-state inverter 613 and inverter 614 to latch the scan data value placed on latch node 626 may be similar to that described above for the normal operating mode.

The pulse dynamic gate illustrated in FIG. 6 may be understood to implement a multiplexed-data style of scan, which may also be referred to as MUX-D. Generally speaking, in MUX-D scan, scan data may be multiplexed onto the same path as functionally-generated data under control of the same clock that is used during normal functional mode (i.e., non-scan) operation. Another style of scan implementation is level-sensitive scan design (LSSD), which may employ a scan clock that is distinct from the functional-mode clock. The use of a separate scan clock may enable more robust scan timing performance (e.g., by reducing hold time issues associated with scan), though LSSD gates may require more area than comparable MUX-D gates.

FIG. 7 illustrates an example of a pulse dynamic gate that implements LSSD-style scan functionality. In the illustrated embodiment, LSSD pulse dynamic gate 700 receives one or more data input signals 702 coupled to an evaluation network 710, as well as a variety of clock signals. The pulse input 703 may correspond to a pulse signal generated in a fashion similar to that discussed above with respect to FIG. 6. The signal clk 701 may correspond to the clock from which the pulse is generated, or an equivalent clock (e.g., in the event that pulse 703 is not generated directly from clk 701, but instead from a clock signal that is upstream or downstream from clk 701). The signals sclk_m 704 and sclk_s 708 denote master and slave scan clocks, respectively, and xclk_m 705 and xclk_s 709 denote the inverse of these scan clocks. The primary data output of the illustrated LSSD pulse dynamic gate is denoted out 750, and the scan data input and scan data output are denoted sdi 706 and sdo 710, respectively.

In some embodiments, LSSD pulse dynamic gate 700 may operate as follows. Operation may depend on whether or not the gate is operating in scan mode. Considering first a normal, non-scan mode of operation, sclk_m 704 and sclk_s 708 may be set to a low state, and their inverses xclk_m 705 and xclk_s 709 may be set to a high state.

Operation may further depend on the state of clk 701 and pulse 703. Initially, clk 701 and pulse 703 may be set to a low state (e.g., a logic 0 represented by a low voltage sufficient to turn on a PFET device and turn off an NFET device), placing gate 700 in a precharge state. In the illustrated embodiment, transistor 719 may be off and 720 may be on, causing dynamic node 715 to be precharged to a high state (e.g., a logic 1 represented by a high voltage sufficient to turn off a PFET device and turn on an NFET device), in turn causing transistor 721 to be off and transistor 722 to be on. Additionally, in this state, transistors 726 and 731 may be on (via sclk_m 704 and clk 701 being low and high, respectively). This may cause the node RTZ 716 to be high, enabling transistor 725 and disabling transistor 724. (The node RTZ 716 may also be referred to more generically as a feedback node.) Via transistors 722 and 725 being on, there exists a path from output 750 to ground, causing output 750 to be low.

To begin the transition from precharge to evaluate mode, clk 701 may transition to a high state. In the illustrated embodiment, the transition on clk 701 may cause transistor 731 to turn off and transistor 729 to turn on. The state of node RTZ 716 may not change at this time, because as long as output 750 remains in a low, precharge-mode state, transistor 727 will remain on and transistor 728 will remain off, keeping RTZ 716 high.

After clk 701 transitions high, pulse 703 may transition high, and gate 700 may enter evaluate mode. In the illustrated embodiment, this transition on pulse 703 may turn on transistors 719 and 723 and turn off transistor 720. Depending on the state of input(s) 702, evaluate tree 710 then may or may not discharge dynamic node 715. For example, the state of the input signals may or may not create a path from dynamic node 715 to ground through evaluate tree 710 and transistor 719.

Assuming that dynamic node 715 does not discharge, node RTZ 716 and output 750 may remain in their precharge states during evaluate mode. Eventually, pulse 703 and clk 701 may transition back to a low state, and gate 700 may responsively return to the precharge state described above.

Assuming that dynamic node 715 does discharge, output 750 may transition to a high state. In the illustrated embodiment, discharge of dynamic node 715 may turn transistor 722 off and transistor 721 on, and the latter device may pull up output 750. The high state on output 750 may cause transistor 727 to turn off and transistor 728 to turn on. Because transistors 729 and 730 are already on (due to clk 701 and xsclk_m 705 both being high), node RTZ 716 may discharge to ground in response to the rising transition on output 750. This in turn may turn on transistor 724 and turn off transistor 725, creating a feedback loop that causes output 750 to continue to be pulled high via transistor 724 regardless of the state of dynamic node 715. Devices 726-731 may individually or collectively be referred to as feedback devices. In other embodiments, the feedback device(s) of gate 700 may include a different arrangement of transistors, gates, circuits, or the like.

Subsequent to the discharge of dynamic node 715, pulse 703 may return to a low state. In the illustrated embodiment, transistor 719 and 723 responsively turn off while transistor 720 responsively turns on, causing dynamic node 715 to begin precharging. However, the feedback loop discussed above may keep output 750 high during the period between the falling edge of pulse 703 and the falling edge of clk 701.

More specifically, in the illustrated embodiment, output 750 is implemented in a return-to-zero format in which it is held until the falling edge of clk 701 and then reset to zero if output 750 is in a nonzero state. For example, as discussed above, when output 750 is low, node RTZ 716 may be high regardless of the state of clk 701, causing output 750 to be held low throughout the duration of clk 701 if dynamic node 715 remains precharged. Output 750 may go high during the evaluate phase (e.g., when pulse 703 is high) if evaluation tree 710 discharges dynamic node 715. In this event, so long as both the output and clk remain high, the RTZ node will be low, causing the output to remain high through the pullup device controlled by the RTZ node.

Eventually, clk 701 will return to a low state. When it does, the NAND structure that drives the RTZ node (e.g., transistors 727, 728, 729, and 731) may cause node RTZ 716 to rise, which in turn may cause output 750 to transition low via transistors 725 and 722. That is, the falling edge of clk 701 may cause output 750 to reset to a low state if it was in a high state, or to remain in a low state if already low. It is noted that while an RTZ output may be useful in interfacing a dynamic gate to other types of logic (e.g., static logic), this style of output is optional, and in other embodiments, an LSSD pulse dynamic gate may be implemented with any suitable type of output.

Once clk 701 returns to a low state, the cycle is complete, and another precharge-evaluate cycle may occur.

During scan mode operation of gate 700, external scan data may be loaded onto output 750, or the current state of output 750 may be captured and output to the scan chain via sdo 710. Depending on the sequencing of master and slave scan clocks sclk_m 704 and sclk_s 708, in some embodiments it may be possible to both capture the current state of output 750 and load external scan data onto output 750, or to load external scan data onto output 750 and cause this external data to also be output to the scan chain.

External data may be loaded onto the output node of the illustrated gate via the sdi 706 input. In the illustrated embodiment, sclk_m 704 may initially be set high, which may disable the RTZ NAND structure by deactivating transistor 726 and may enable the clock-qualified inverter 711 coupled to sdi 706. (The devices included in inverter 711 may individually or collectively be referred to as scan input devices, and in other embodiments, a different arrangement of scan input devices may be employed.) This in turn may cause the inverse of sdi 706 to be coupled to node RTZ 716. That is, if sdi 706 is low, RTZ 716 may be high, causing output 750 to be driven low via transistors 725 and 722. Conversely, if sdi 706 is high, RTZ 716 may be low, causing output 750 to be driven high via transistor 724.

The current data that is present on output 750 may then be latched. As noted above, the current data may either be the data that was just loaded via sdi 706, or the current state of output 750 as a result of evaluation of evaluation tree 710. In the illustrated embodiment, the capture of output 750 into slave latch 712 may be initiated by returning sclk_m 704 to a low state (if it was asserted) and setting sclk_s 708 and xsclk_s 709 to high and low states, respectively. This may cause the data held at output 750 of pulse dynamic gate 700 to be transferred through pass transistors 708-709 to the scan data output port sdo 710. When the state of output 750 has been captured by latch 712, clk_s 708 may go low and xclk_s 709 may go high. At this point, the pass transistors 708-709 may close and the state of output 750 may be held in the illustrated pair of keeper inverters within latch 712. After clk_s 708 goes low and the data has been latched in the slave latch, pulse dynamic 700 gate may then return to a precharge state.

In some embodiments, the sdo 710 output of one pulse dynamic gate may be coupled to the sdi 706 input of another pulse dynamic gate to form a scan chain. It is noted that if sclk_m 704 and sclk_s 708 are sequentially pulsed in an alternating fashion, a sequence of scan data may be propagated along the scan chain to load data into gates along the scan chain and/or to read data from those gates.

It is noted that although various specific circuit arrangements and device types have been discussed above, in other embodiments, other types of circuits, design styles, and/or device types may be employed. For example, although CMOS circuits employing N-type and P-type field effect transistors (NFETs and PFETs, respectively) have been shown and described above, in other embodiments, other types of devices (such as, e.g., bipolar junction transistors or other suitable types of switching devices) may be employed. Moreover, in some embodiments, low-vt transistors (i.e., transistors having relatively lower threshold voltages for activation) may be used in the pulse generation circuit and/or elsewhere within a gate to reduce the pulse length and consequently reduce the gate's hold time.

### Processor Overview

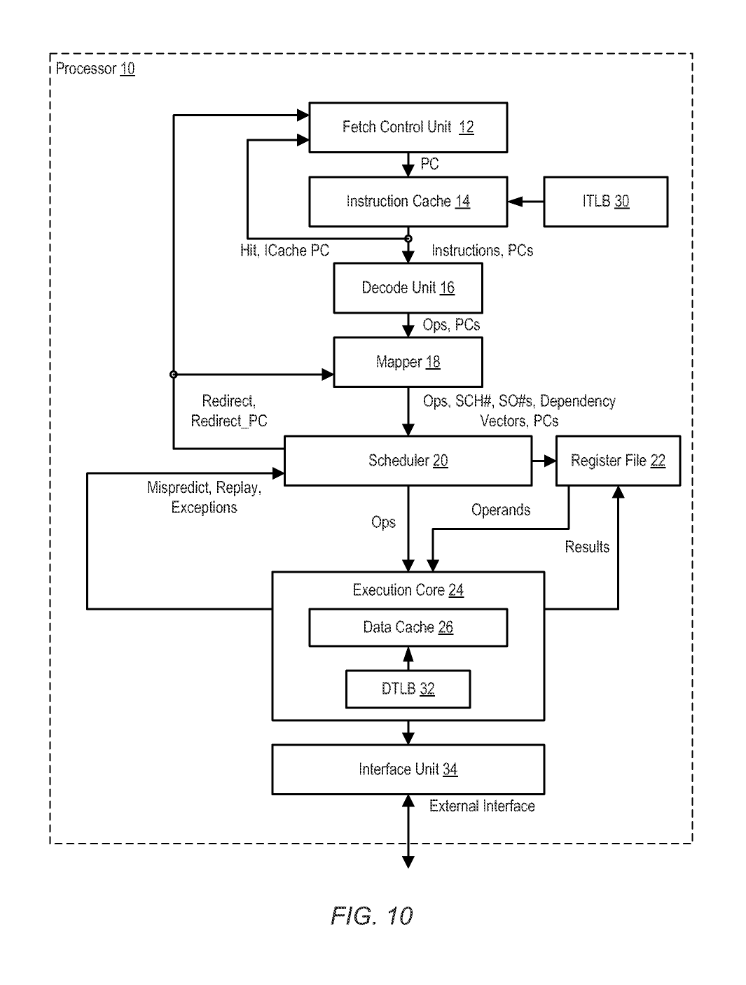

Turning now to FIG. 10, a block diagram of an embodiment of a processor 10 is shown. Processor 10 may include one or more adders that incorporate some or all of the features described above. In the illustrated embodiment, the processor 10 includes a fetch control unit 12, an instruction cache 14, a decode unit 16, a mapper 18, a scheduler 20, a register file 22, an execution core 24, and an interface unit 34. The fetch control unit 12 is coupled to provide a program counter address (PC) for fetching from the instruction cache 14. The instruction cache 14 is coupled to provide instructions (with PCs) to the decode unit 16, which is coupled to provide decoded instruction operations (ops, again with PCs) to the mapper 18. The instruction cache 14 is further configured to provide a hit indication and an ICache PC to the fetch control unit 12. The mapper 18 is coupled to provide ops, a scheduler number (SCH#), source operand numbers (SO#s), one or more dependency vectors, and PCs to the scheduler 20. The scheduler 20 is coupled to receive replay, mispredict, and exception indications from the execution core 24, is coupled to provide a redirect indication and redirect PC to the fetch control unit 12 and the mapper 18, is coupled to the register file 22, and is coupled to provide ops for execution to the execution core 24. The register file is coupled to provide operands to the execution core 24, and is coupled to receive results to be written to the register file 22 from the execution core 24. The execution core 24 is coupled to the interface unit 34, which is further coupled to an external interface of the processor 10.

Fetch control unit 12 may be configured to generate fetch PCs for instruction cache 14. In some embodiments, fetch control unit 12 may include one or more types of branch predictors. For example, fetch control unit 12 may include indirect branch target predictors configured to predict the target address for indirect branch instructions, conditional branch predictors configured to predict the outcome of conditional branches, and/or any other suitable type of branch predictor. During operation, fetch control unit 12 may generate a fetch PC based on the output of a selected branch predictor. If the prediction later turns out to be incorrect, fetch control unit 12 may be redirected to fetch from a different address. When generating a fetch PC, in the absence of a nonsequential branch target (i.e., a branch or other redirection to a nonsequential address, whether speculative or non-speculative), fetch control unit 12 may generate a fetch PC as a sequential function of a current PC value. For example, depending on how many bytes are fetched from instruction cache 14 at a given time, fetch control unit 12 may generate a sequential fetch PC by adding a known offset to a current PC value.

The instruction cache 14 may be a cache memory for storing instructions to be executed by the processor 10. The instruction cache 14 may have any capacity and construction (e.g. direct mapped, set associative, fully associative, etc.). The instruction cache 14 may have any cache line size. For example, 64 byte cache lines may be implemented in an embodiment. Other embodiments may use larger or smaller cache line sizes. In response to a given PC from the fetch control unit 12, the instruction cache 14 may output up to a maximum number of instructions. It is contemplated that processor 10 may implement any suitable instruction set architecture (ISA), such as, e.g., the ARM™, PowerPC™, or x86 ISAs, or combinations thereof.

In some embodiments, processor 10 may implement an address translation scheme in which one or more virtual address spaces are made visible to executing software. Memory accesses within the virtual address space are translated to a physical address space corresponding to the actual physical memory available to the system, for example using a set of page tables, segments, or other virtual memory translation schemes. In embodiments that employ address translation, the instruction cache 14 may be partially or completely addressed using physical address bits rather than virtual address bits. For example, instruction cache 14 may use virtual address bits for cache indexing and physical address bits for cache tags.

In order to avoid the cost of performing a full memory translation when performing a cache access, processor 10 may store a set of recent and/or frequently-used virtual-to-physical address translations in a translation lookaside buffer (TLB), such as Instruction TLB (ITLB) 30. During operation, ITLB 30 (which may be implemented as a cache, as a content addressable memory (CAM), or using any other suitable circuit structure) may receive virtual address information and determine whether a valid translation is present. If so, ITLB 30 may provide the corresponding physical address bits to instruction cache 14. If not, ITLB 30 may cause the translation to be determined, for example by raising a virtual memory exception.

The decode unit 16 may generally be configured to decode the instructions into instruction operations (ops). Generally, an instruction operation may be an operation that the hardware included in the execution core 24 is capable of executing. Each instruction may translate to one or more instruction operations which, when executed, result in the operation(s) defined for that instruction being performed according to the instruction set architecture implemented by the processor 10. In some embodiments, each instruction may decode into a single instruction operation. The decode unit 16 may be configured to identify the type of instruction, source operands, etc., and the decoded instruction operation may include the instruction along with some of the decode information. In other embodiments in which each instruction translates to a single op, each op may simply be the corresponding instruction or a portion thereof (e.g. the opcode field or fields of the instruction). In some embodiments in which there is a one-to-one correspondence between instructions and ops, the decode unit 16 and mapper 18 may be combined and/or the decode and mapping operations may occur in one clock cycle. In other embodiments, some instructions may decode into multiple instruction operations. In some embodiments, the decode unit 16 may include any combination of circuitry and/or microcoding in order to generate ops for instructions. For example, relatively simple op generations (e.g. one or two ops per instruction) may be handled in hardware while more extensive op generations (e.g. more than three ops for an instruction) may be handled in microcode.

Ops generated by the decode unit 16 may be provided to the mapper 18. The mapper 18 may implement register renaming to map source register addresses from the ops to the source operand numbers (SO#s) identifying the renamed source registers. Additionally, the mapper 18 may be configured to assign a scheduler entry to store each op, identified by the SCH#. In an embodiment, the SCH# may also be configured to identify the rename register assigned to the destination of the op. In other embodiments, the mapper 18 may be configured to assign a separate destination register number. Additionally, the mapper 18 may be configured to generate dependency vectors for the op. The dependency vectors may identify the ops on which a given op is dependent. In an embodiment, dependencies are indicated by the SCH# of the corresponding ops, and the dependency vector bit positions may correspond to SCH#s. In other embodiments, dependencies may be recorded based on register numbers and the dependency vector bit positions may correspond to the register numbers.

The mapper 18 may provide the ops, along with SCH#, SO#s, PCs, and dependency vectors for each op to the scheduler 20. The scheduler 20 may be configured to store the ops in the scheduler entries identified by the respective SCH#s, along with the SO#s and PCs. The scheduler may be configured to store the dependency vectors in dependency arrays that evaluate which ops are eligible for scheduling. The scheduler 20 may be configured to schedule the ops for execution in the execution core 24. When an op is scheduled, the scheduler 20 may be configured to read its source operands from the register file 22 and the source operands may be provided to the execution core 24. The execution core 24 may be configured to return the results of ops that update registers to the register file 22. In some cases, the execution core 24 may forward a result that is to be written to the register file 22 in place of the value read from the register file 22 (e.g. in the case of back to back scheduling of dependent ops).

The execution core 24 may also be configured to detect various events during execution of ops that may be reported to the scheduler. Branch ops may be mispredicted, and some load/store ops may be replayed (e.g. for address-based conflicts of data being written/read). Various exceptions may be detected (e.g. protection exceptions for memory accesses or for privileged instructions being executed in non-privileged mode, exceptions for no address translation, etc.). The exceptions may cause a corresponding exception handling routine to be executed.

The execution core 24 may be configured to execute predicted branch ops, and may receive the predicted target address that was originally provided to the fetch control unit 12. The execution core 24 may be configured to calculate the target address from the operands of the branch op, and to compare the calculated target address to the predicted target address to detect correct prediction or misprediction. The execution core 24 may also evaluate any other prediction made with respect to the branch op, such as a prediction of the branch op's direction. If a misprediction is detected, execution core 24 may signal that fetch control unit 12 should be redirected to the correct fetch target. Other units, such as the scheduler 20, the mapper 18, and the decode unit 16 may flush pending ops/instructions from the speculative instruction stream that are subsequent to or dependent upon the mispredicted branch.

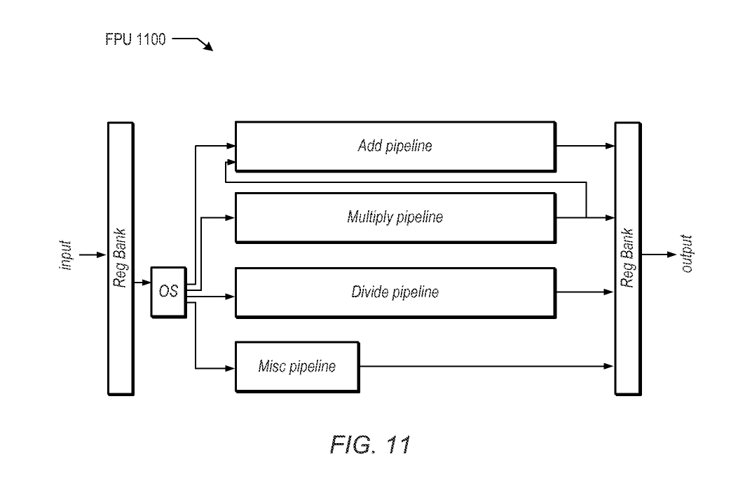

In some embodiments, execution core 24 or another unit of processor 10 may include a floating-point unit (FPU) configured to execute floating-point instructions. Such an FPU may include a hybrid adder including a dynamic carry tree of the type discussed above with respect to FIGS. 2-3, or a suitable variant thereof. An example organization of an FPU, denoted FPU 1100, is shown in FIG. 11. In the illustrated embodiment, various FPU sub-units are shown. It is noted that in various embodiments, the functionality of FPU 1100 may be partitioned into various pipeline stages according to any suitable set of pipeline boundaries, and may employ more or fewer sub-units than shown.

In the illustrated embodiment, FPU operations may begin with the selection of operands (e.g., from a register file and/or a bypass network) under the control of operand selection logic OS. For example, in some embodiments, up to three 64-bit operands may be selected for various operations. Depending on the nature of the operation, an FPU operation may then issue into one or more of several different execution pipelines. For example, add/subtract operations may enter an adder pipeline that may span multiple pipeline stages. At various stages in the pipeline, corresponding aspects of floating-point addition may be performed, such as exception detection, mantissa alignment, summation, normalization, rounding, and sign extension, among others. For example, in the illustrated embodiment, the hybrid adder discussed above may be included within the adder pipeline.

FPU 1100 also includes a multiply pipeline. As with the adder pipeline, various stages of the multiply pipeline may perform corresponding aspects of floating-point multiplication, such as Booth encoding, accumulation of partial products via an adder tree, final product determination, normalization, and rounding, among others. The illustrated embodiment further provides a direct path from the output of the multiply pipeline to the input of the adder pipeline to speed addition operations that directly depend on multiplication operations. FPU 1100 further includes a divide pipeline. The divide pipeline includes various stages that may implement iterative algorithms to perform division as well as other operations, such as square root.

FPU 1100 may also include other sub-units. For example, a miscellaneous execution pipeline may be provided to execute various floating-point instructions that do not require the complexity or latency of addition, multiplication, or division (such as, e.g., move operations or absolute value operations). In some embodiments, other sub-units not shown in FIG. 11 may also be provided, e.g., in order to track utilization of operands and assure proper operand selection, and/or to provide support for load/store operations.

Returning to FIG. 10, the execution core may include a data cache 26, which may be a cache memory for storing data to be processed by the processor 10. Like the instruction cache 14, the data cache 26 may have any suitable capacity, construction, or line size (e.g. direct mapped, set associative, fully associative, etc.). Moreover, the data cache 26 may differ from the instruction cache 14 in any of these details. As with instruction cache 14, in some embodiments, data cache 26 may be partially or entirely addressed using physical address bits. Correspondingly, a data TLB (DTLB) 32 may be provided to cache virtual-to-physical address translations for use in accessing the data cache 26 in a manner similar to that described above with respect to ITLB 30. It is noted that although ITLB 30 and DTLB 32 may perform similar functions, in various embodiments they may be implemented differently. For example, they may store different numbers of translations and/or different translation information.

The register file 22 may generally include any set of registers usable to store operands and results of ops executed in the processor 10. In some embodiments, the register file 22 may include a set of physical registers and the mapper 18 may be configured to map the logical registers to the physical registers. The logical registers may include both architected registers specified by the instruction set architecture implemented by the processor 10 and temporary registers that may be used as destinations of ops for temporary results (and sources of subsequent ops as well). In other embodiments, the register file 22 may include an architected register set containing the committed state of the logical registers and a speculative register set containing speculative register state.

The interface unit 34 may generally include the circuitry for interfacing the processor 10 to other devices on the external interface. The external interface may include any type of interconnect (e.g. bus, packet, etc.). The external interface may be an on-chip interconnect, if the processor 10 is integrated with one or more other components (e.g. a system on a chip configuration). The external interface may be on off-chip interconnect to external circuitry, if the processor 10 is not integrated with other components. In various embodiments, the processor 10 may implement any instruction set architecture.

### System and Computer Accessible Storage Medium

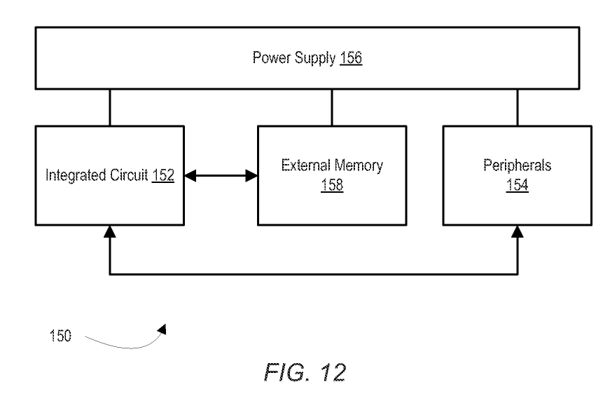

Turning next to FIG. 12, a block diagram of an embodiment of a system 150 is shown. In the illustrated embodiment, the system 150 includes at least one instance of an integrated circuit 152. The integrated circuit 152 may include one or more instances of the processor 10 (from FIG. 10). The integrated circuit 152 may, in an embodiment, be a system on a chip including one or more instances of the processor 10 and various other circuitry such as a memory controller, video and/or audio processing circuitry, on-chip peripherals and/or peripheral interfaces to couple to off-chip peripherals, etc. The integrated circuit 152 is coupled to one or more peripherals 154 and an external memory 158. A power supply 156 is also provided which supplies the supply voltages to the integrated circuit 152 as well as one or more supply voltages to the memory 158 and/or the peripherals 154. In some embodiments, more than one instance of the integrated circuit 152 may be included (and more than one external memory 158 may be included as well).

The peripherals 154 may include any desired circuitry, depending on the type of system 150. For example, in an embodiment, the system 150 may be a mobile device (e.g. personal digital assistant (PDA), smart phone, etc.) and the peripherals 154 may include devices for various types of wireless communication, such as wifi, Bluetooth, cellular, global positioning system, etc. The peripherals 154 may also include additional storage, including RAM storage, solid state storage, or disk storage. The peripherals 154 may include user interface devices such as a display screen, including touch display screens or multitouch display screens, keyboard or other input devices, microphones, speakers, etc. In other embodiments, the system 150 may be any type of computing system (e.g. desktop personal computer, laptop, workstation, net top etc.).

The external memory 158 may include any type of memory. For example, the external memory 158 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, RAMBUS DRAM, etc. The external memory 158 may include one or more memory modules to which the memory devices are mounted, such as single inline memory modules (SIMMs), dual inline memory modules (DIMMs), etc.

Numerous variations and modifications will become apparent to those skilled in the art once the above disclosure is fully appreciated. It is intended that the following claims be interpreted to embrace all such variations and modifications.

What is claimed is:

1. An apparatus, comprising:
a plurality of static partial sum circuits that operate to generate partial sums of two or more operands, wherein each of the two or more operands is divided into a plurality of groups, and wherein at least some of the groups include a plurality of bits;
wherein each of a first subset of the static partial sum circuits, during operation, generates a respective partial sum of a corresponding group of the two or more operands assuming a carry in of 0 to the corresponding group;
wherein each of a second subset of the static partial sum circuits, during operation, generates a respective partial sum of a corresponding group of the two or more operands assuming a carry in of 1 to the corresponding group;
a dynamic carry tree circuit that, during operation, generates a plurality of arithmetic carry signals, wherein each of the arithmetic carry signals corresponds to a respective group of sum bits, wherein at least some groups of sum bits include a plurality of sum bits; and
a multiplexer that, during operation, selects each of the groups of sum bits from either of the first or the second subsets of static partial sum circuits dependent upon corresponding ones of the arithmetic carry signals.

2. The apparatus of claim 1, wherein the dynamic carry tree circuit includes a plurality of clocked domino logic gates.

3. The apparatus of claim 1, wherein the dynamic carry tree circuit includes a first stage comprising a plurality of pulse domino logic gates and a second stage comprising a plurality of clocked domino logic gates.

4. The apparatus of claim 1, wherein the dynamic carry tree circuit includes a first dynamic logic stage that operates to convert static input signals of the dynamic carry tree circuit to dynamic signals, a second dynamic logic stage coupled to the first dynamic logic stage, and a third dynamic logic stage coupled to the second dynamic logic stage that operates to convert dynamic signals to static output signals of the dynamic carry tree circuit.

5. The apparatus of claim 4, wherein at least some of the static output signals of the dynamic carry tree circuit are coupled to control the multiplexer.

6. The apparatus of claim 1, wherein one or more logic gates included within the dynamic carry tree circuit are coupled to signals encoded in a 1-of-N format.

7. The apparatus of claim 1, wherein each of the arithmetic carry signals explicitly encodes a propagate signal and a generate signal without explicitly encoding a halt signal.

8. The apparatus of claim 1, wherein each of the groups includes three bits.

9. The apparatus of claim 7, wherein each of the two or more operands is at least 78 bits in length.

10. A processor, comprising:
instruction fetch logic configured to issue instructions for execution; and
a datapath configured to execute at least some of the instructions, wherein the datapath comprises an adder that, during operation, adds two or more operands to produce a sum;
wherein the adder comprises:
a plurality of static partial sum circuits that, during operation, generate partial sums of the two or more operands;
a dynamic carry tree circuit that, during operation, generates a plurality of arithmetic carry signals; and
a final sum generation circuit that, during operation, combines the partial sums and the arithmetic carry signals to generate the sum of the two or more operands;
wherein the dynamic carry tree circuit comprises one or more pulse domino logic gates, wherein the one or more pulse domino logic gates each comprise:
an evaluation network coupled to evaluate one or more inputs during assertion of an evaluate pulse and to selectively discharge a dynamic node dependent upon the one or more inputs, wherein the evaluate pulse is derived from a clock signal and is asserted for a shorter duration than the clock signal is asserted; and
one or more output devices coupled to the dynamic node, wherein during operation, the one or more output devices drive an output node dependent upon the dynamic node.

11. The processor of claim 10, wherein the one or more pulse domino logic gates are included within a first dynamic logic stage that operates to convert static input signals of the dynamic carry tree circuit to dynamic signals.

12. The processor of claim 11, wherein the dynamic carry tree circuit further comprises a second dynamic logic stage coupled to the first dynamic logic stage, and a third dynamic logic stage coupled to the second dynamic logic stage, wherein the third dynamic logic stage operates to convert dynamic signals to static output signals of the dynamic carry tree circuit.

13. The processor of claim 10, wherein the dynamic carry tree circuit further comprises one or more clock generators coupled to receive the clock signal and to generate the evaluate pulse from the clock signal, wherein the one or more clock generators are configurable to selectively adjust a rising or falling edge of the evaluate pulse relative to the clock signal.

14. The processor of claim 10, wherein the one or more pulse domino logic gates included within the dynamic carry tree circuit are coupled to signals encoded in a 1-of-N format.

15. The processor of claim 10, wherein each of the arithmetic carry signals explicitly encodes a propagate signal and a generate signal without explicitly encoding a halt signal.

16. A system, comprising:
a memory; and
a processor coupled to the memory, wherein the processor comprises an adder;
wherein the adder comprises:
a plurality of static partial sum circuits that, during operation, generate partial sums of two or more operands;
a dynamic carry tree circuit that, during operation, generates a plurality of arithmetic carry signals; and
a final sum generation circuit that, during operation, combines the partial sums and the arithmetic carry signals to generate a sum of the two or more operands;
wherein the dynamic carry tree circuit comprises one or more pulse domino logic gates, wherein the one or more pulse domino logic gates each comprise:
an evaluation network coupled to evaluate one or more inputs during assertion of an evaluate pulse and to selectively discharge a dynamic node dependent upon the one or more inputs, wherein the evaluate pulse is derived from a clock signal and is asserted for a shorter duration than the clock signal is asserted; and
one or more output devices coupled to the dynamic node, wherein during operation, the one or more output devices drive an output node dependent upon the dynamic node.

17. The system of claim 16,
wherein each of the two or more operands is divided into a plurality of groups;
wherein at least some of the groups include a plurality of bits;
wherein each of a first subset of the static partial sum circuits, during operation, generates a respective partial sum of a corresponding group of the two or more operands assuming a carry in of 0 to the corresponding group; and
wherein each of a second subset of the static partial sum circuits, during operation, generates a respective partial sum of a corresponding group of the two or more operands assuming a carry in of 1 to the corresponding group.

18. The system of claim 17, wherein the final sum generation circuit comprises a multiplexer that, during operation, selects each of the groups of sum bits from either of the first or the second subsets of static partial sum circuits dependent upon corresponding ones of the arithmetic carry signals.

19. A method, comprising:
generating, by a plurality of static partial sum circuits, partial sums of two or more operands;
generating an evaluate pulse from a clock signal, wherein the evaluate pulse is asserted for a shorter duration than the clock signal is asserted;
generating, by a dynamic carry tree circuit, a plurality of arithmetic carry signals, wherein generating the arithmetic carry signals occurs dependent upon the evaluate pulse; and
combining, by a final sum generation circuit, the partial sums and the arithmetic carry signals to output a sum of the two or more operands.

20. The method of claim 19, wherein each of the two or more operands is divided into a plurality of groups, wherein at least some of the groups include a plurality of bits, and wherein generating the partial sums further comprises:
generating, by each of a first subset of the static partial sum circuits, a respective partial sum of a corresponding group of the two or more operands assuming a carry in of 0 to the corresponding group; and
generating, by each of a second subset of the static partial sum circuits, a respective partial sum of a corresponding group of the two or more operands assuming a carry in of 1 to the corresponding group.
